(19) United States
(12) Patent Application Publication
(10) Pub. No.: US 2008/0115419 A1
(43) Pub. Date: May 22, 2008

(54) Adjustable slam bumper for frameless door

(75) Inventor: Santhosh Kumar Karumuri, Inkster, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/603,395

(22) Filed: Nov. 22, 2006

(51) Int. Cl. E06B 3/00

(52) U.S. Cl. 49/501

(57) ABSTRACT

A frameless door assembly includes an adjustable slam bumper that provides support for a window panel when in an open position. The adjustable slam bumper is mounted to a carrier plate and is selectively adjustable to maintain a desired relationship between the adjustable slam bumper and the window panel.

### TECHNICAL FIELD

The subject invention relates to an adjustable slam bumper for a frameless door assembly that provides support for a window panel when in an open position.

### BACKGROUND OF THE INVENTION

Frameless door configurations present unique problems for supporting a window panel within a vehicle door. A window regulator includes rails that are mounted to a door structure, such as a carrier plate for example, that are used to guide movement of a window between an open position and a closed position. When the window is in an open position, i.e. a retracted or down position relative to the carrier plate, the window is unsupported below a belt line of the vehicle door. Because the window is unsupported in this position, when the vehicle door is slammed shut, additional stress is exerted on the rails. As a result, an attachment interface at the rails can fail prior to a desired fatigue limit for door slam cycles.

One known solution is to provide additional brackets at a bottom of the carrier plate for the rails. This solution is not desirable because cost and weight are added, as well as requiring an increase in assembly time.

Another solution utilizes slam bumpers that provide support for the window when in the fully open, i.e. retracted position. One disadvantage with current slam bumpers is that once a window installation position is adjusted to provide a tight seal interface at a top of the window, the positional relationship between the slam bumper and window has been compromised. In other words, when the window is moved to an adjusted installed position, the slam bumper is no longer in a proper position to provide needed support for the window when in the fully open position.

Thus, there is a need for an improved support structure for a frameless vehicle door that provides sufficient support for the vehicle window when in the open position, as well as overcoming the other deficiencies discussed in the prior art above.

### SUMMARY OF THE INVENTION

A slam bumper is used in a frameless door assembly to provide support for a window panel when in an open position. The slam bumper is selectively adjustable to maintain a desired relationship between the slam bumper and the window panel.

In one example, the slam bumper includes a first body portion that is threaded into engagement with a carrier plate, a second body portion that includes an adjustment feature, and a third body portion with a bump surface. The first body portion is between and interconnects the second and third body portion such that the second body portion is positioned on one side of the carrier plate and the third body portion is positioned on an opposite side of the carrier plate.

In one example, the adjustment feature comprises a slot that is adapted to receive a tool. The tool is used to rotate the slam bumper until the slam bumper contacts a window regulator rail. This defines the desired relationship between the slam bumper and the window panel.

In one example, the third body portion has a diameter that is less than a diameter of the first body portion. This forms a stop surface that transitions from the first body portion to the second body portion. A position of the slam bumper is adjusted until the stop surface engages the window regulator rail.

In one example, a first slam bumper is mounted to the carrier plate at a first position and a second slam bumper is mounted to the carrier plate at a second position that is vertically higher than the first position. The first slam bumper provides support for the window panel when the window panel is in a fully open position. The second slam bumper provides support for the window panel when the window panel is in a position between the fully open position and a fully closed position.

Adjustable slam bumpers are a cost effective solution for providing additional window panel support, are easily installed, and eliminate the need for additional brackets to support a window panel in a frameless door. Further, by being adjustable, it is easy to maintain a desired relationship between the slam bumpers and an associated window in response to changes in window installation positions. These and other features of the present invention can be best understood from the following specification and drawings, the following of which is a brief description.

### BRIEF DESCRIPTION OF THE DRAWINGS

FIG. 1 shows a frameless vehicle door assembly utilizing adjustable slam bumpers.

FIG. 2 is a perspective view of an adjustable slam bumper.

FIG. 3 shows a dry side view of the adjustable slam bumpers as installed in a carrier plate.

FIG. 4 shows a wet side view of the adjustable slam bumpers as installed in a carrier plate.

FIG. 5 shows an adjustable slam bumper extending through a window regulator rail.

FIG. 6 shows an adjustment mechanism for adjusting window installation positions.

FIG. 7 shows a carrier plate without adjustable slam bumpers installed.

FIG. 8 shows an adjustable slam bumper cooperating with the window regulator rail to define a desired positional relationship between the window and the adjustable slam bumper when the window is in a fully open (retracted) position.

FIG. 9 shows one example of a sealed interface for the carrier plate and adjustable slam bumper.

### DETAILED DESCRIPTION OF THE PREFERRED EMBODIMENT

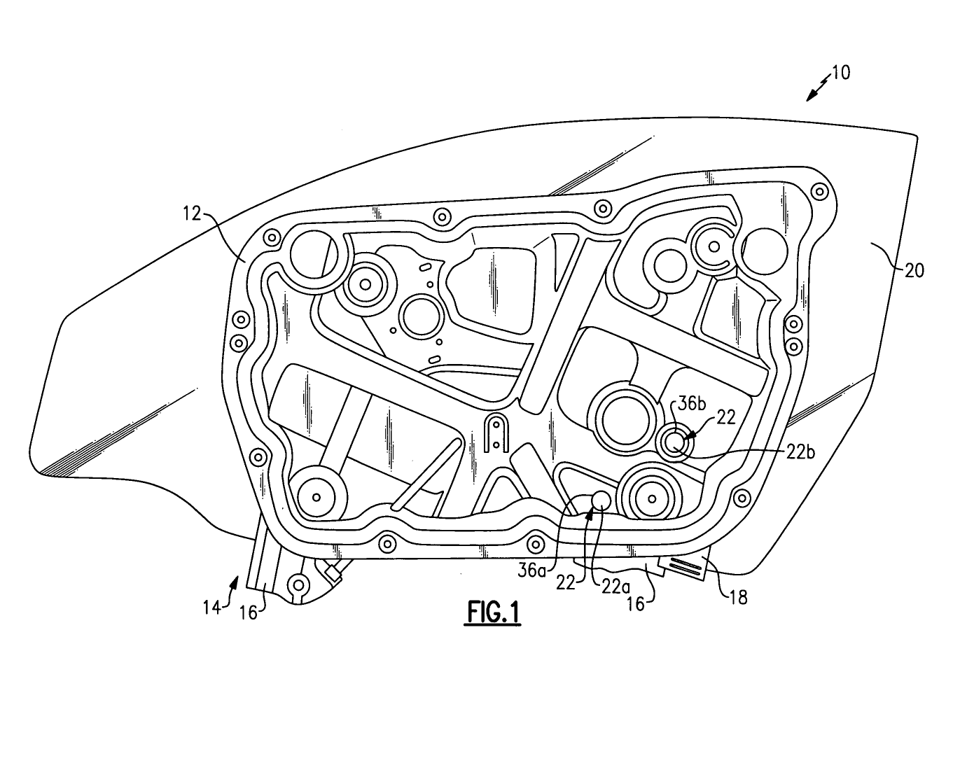

A frameless vehicle door 10 is partly shown in FIG. 1. The frameless vehicle door 10 includes a carrier plate 12 that supports a window regulator assembly 14. The window regulator assembly 14 includes rails 16 that are mounted to the carrier plate 12, and cursors (only one is shown) 18 associated with each rail 16 that support a window panel 20. The window panel 20 is usually made from glass; however, other materials could also be used. The rails 16 define a guide path for the cursors 18, which move the window panel 20 upwardly and downwardly relative to the carrier plate 12 to move the window panel 20 between open and closed positions.

The frameless vehicle door 10 is used in a vehicle such as a convertible for example, that does not include structure frame elements to engage and support sides of the window panel 20. The window panel 20 is required to be sufficiently sealed at window edges, i.e. top, bottom, and side edges, when in the fully closed (raised) position.

At least one slam bumper 22 is mounted to the carrier plate 12 to provide additional support for the window panel 20 when in the open position. In the example shown, a first slam bumper 22a is used to provide support for the window panel when in the fully open position and a second slam bumper 22b is used to provide additional support for the rail 16 when the window panel 20 is at a position between fully opened and fully closed. The slam bumpers 22 are selectively adjustable to maintain a desired position relative to the rail 16 and/or window panel 20. This will be discussed in greater detail below.

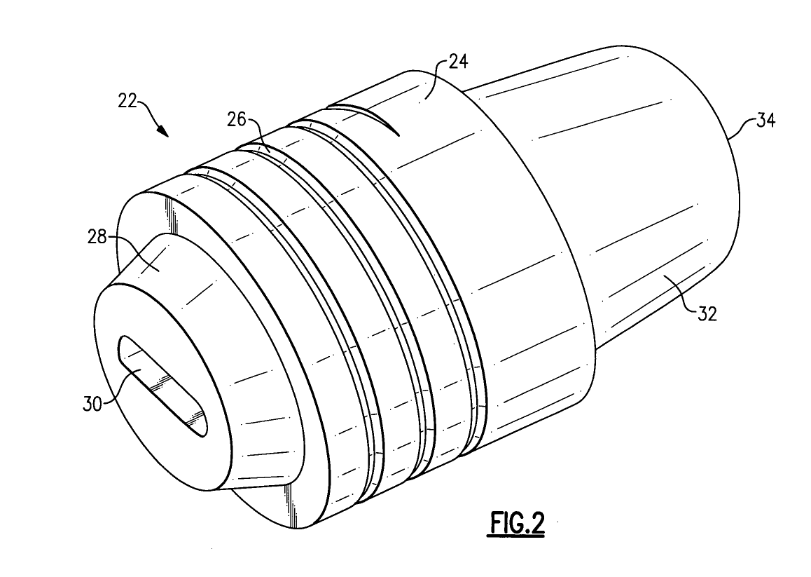

A slam bumper 22 is shown in greater detail in FIG. 2. The slam bumper 22 has a first body portion 24 that has a threaded outer surface 26, a second body portion 28 that has an adjustment feature 30, and a third body portion 32 that defines a bump surface 34. The first 24, second 28, and third 32 body portions are formed as a single piece component with the first body portion 24 being positioned between the second 28 and third 32 body portions.

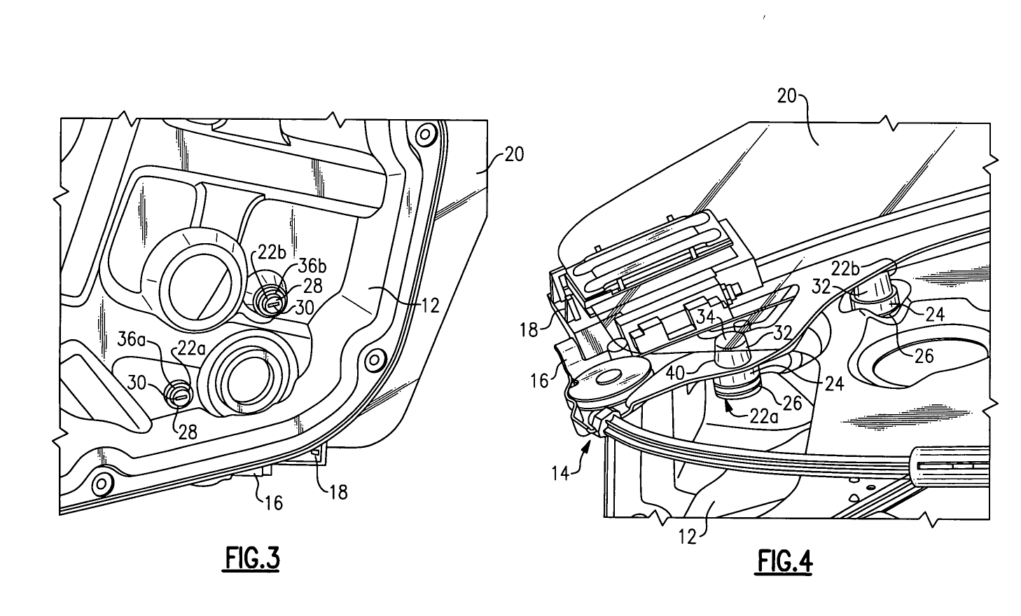

The first body portion 24 is threaded into attachment with the carrier plate 12 via the threaded outer surface 26. The carrier plate 12 has openings 36a, 36b (FIGS. 1 and 3) that receive the first 22a and second 22b slam bumpers. These openings 36a, 36b extend entirely through a thickness of the carrier plate 12. When threaded through the openings 36a, 36b, the second body portion 28 is positioned on a dry side of the frameless vehicle door 10 (FIG. 3) and the third body portion 32 is positioned on a wet side of the frameless vehicle door 10 (FIG. 4).

As shown in FIGS. 2 and 3, the adjustment feature 30 preferably comprises a slot or other type of engagement feature that is adapted to receive a tool, such as a screwdriver for example. The adjustment feature 30 allows the slam bumper 22 to be rotated such that a desired position relationship between the window panel 20 and the bump surface 34 can be maintained throughout all window panel adjustment positions.

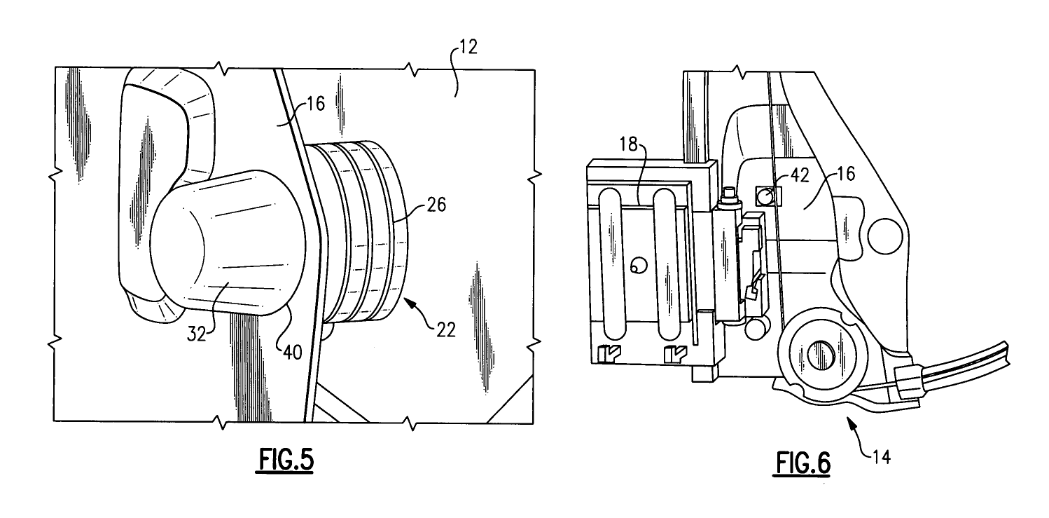

As shown in FIGS. 4 and 5, the first slam bumper 22a extends through an opening 40 in the rail 16 such that the bump surface 34 extends beyond the rail 16. The bump surface 34 provides additional support for the window panel 20 when in the fully open (retracted) position during door slam events. The second slam bumper 22b is positioned vertically higher than the first slam bumper 22a (see FIGS. 1 and 3) and has the bump surface 34 engage the rail 16. This provides additional support for the rail 16 when the window panel 20 is at a position between fully open and fully closed during a slam event.

As shown in FIG. 5, the diameter of the first body portion 24 of the slam bumper 22 is greater than a diameter of the third body portion 32. This creates a stop surface that engages the rail 16 to position the slam bumper 22 at the desired position for maintaining a desired spaced relationship between the bump surface 34 and the window panel 20. This will be discussed in greater detail below.

When a window panel 20 and associated carrier plate 12 with window regulator assembly 14 are installed within a frameless vehicle door 10, an adjustment is required to properly position the window panel 20 within the vehicle door such that a tight seal is provided between a top edge of the window panel 20 and a roof sealing structure (not shown). To accomplish this adjustment, an adjustment screw 42 (FIG. 6) is adjusted as known, which moves the rail 16, and thus the cursor 18 and window panel 20, to a desired installation position.

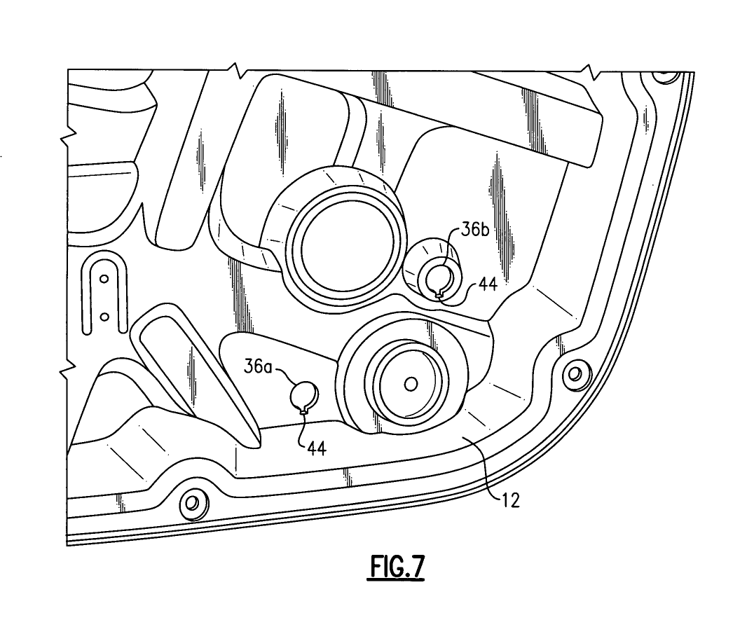

As shown in FIG. 7, the openings 36a, 36b for the first 22a and second 22b slam bumpers each include a notch 44. The notch 44 provides a starting position for threading the first 22a and second 22b slam bumpers into the carrier plate 12; on the FIG. 2, the threaded portion should end at a stop surface to engage the rail 16. Once the rail 16 is positioned in the desired installation position by the adjustment screw 42, the slam bumpers 22 are then selectively adjusted relative to the carrier plate 12 to maintain a desired position relative to the window panel 20 and/or window rail 16.

As discussed above, a stop surface 50 is created at a transition between the first body portion 24 and the third body portion 32, see FIG. 8. For the first slam bumper 22a, this stop surface 50 engages a rail surface 52 to maintain a desired positional relationship between the bump surface 34 and the window panel 20 when the window panel 20 is in the fully open, fully retracted position. The adjustment feature 30 is engaged to rotate the first slam bumper 22a about an axis A, which moves first slam bumper 22a axially along the axis A in a direction toward the rail 16. The first slam bumper 22a is rotated until the stop surface 50 engages the rail surface 52. This engagement positively defines a desired gap G between the bump surface 34 and a window surface 56 of the window panel 20. When a frameless vehicle door 10 is slammed, the first slam bumper 22a provides support for the window panel 20 and the rail 16.

The second slam bumper 22b also provides additional support. As shown in FIG. 4, the adjustment feature 30 (FIG. 3) of the second slam bumper 22b is selectively rotated to move the second slam bumper 22b toward the rail 16. The second slam bumper 22b is rotated until the bump surface 34 contacts the rail 16. This provides additional support for the rail 16 and the associated window panel 20 when the window panel 20 is at position between fully open and fully closed.

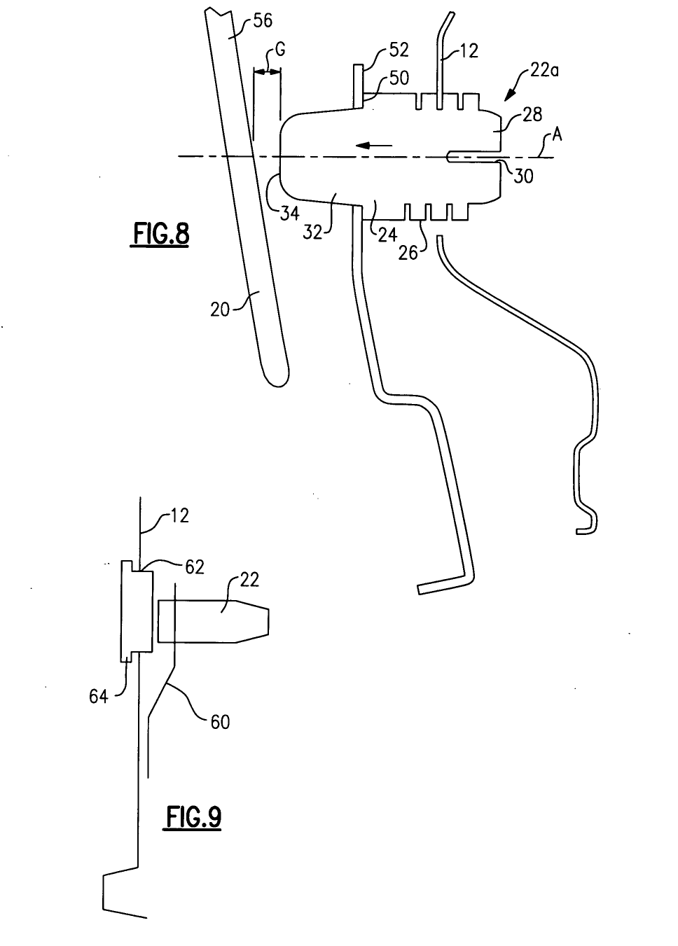

The interface between the slam bumper 22 and carrier plate 12 is also a sealed interface. In the configurations shown in FIGS. 1-8, a piece of tape or other type of adhesive can be placed over the slam bumper 22 to provide sealing. In another example, shown in FIG. 9, a bracket 60 is attached to the carrier plate 12 with the slam bumper 22 being threaded through the bracket 60. An access hole 62 is provided in the carrier plate 12 to allow selective adjustment as described above. After adjustment, a cover 64 is used to cover and seal the access hole 62. The cover 64 can be formed from rubber for example, or other types of sealing materials could also be used.

The use of adjustable slam bumpers 22 improves fatigue life for door slam cycles by reducing stress loading at rail attachment interfaces. Further, the adjustable slam bumpers provide a cost savings compared to using brackets, as well as provided a method for maintaining a desired positional relationship between the slam bumper and the window panel at all window panel adjustment positions.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A frameless door assembly comprising:
an inner door structure;
a window regulator rail supported by said inner door structure;
a window support structure guided for movement by said window regulator rail, said window support structure adapted to hold a window panel; and
at least one slam bumper mounted to said inner door structure and positionally adjustable relative to said window regulator rail to maintain a desired positional relationship between the window panel and said at least one slam bumper.

2. The frameless door assembly according to claim 1 wherein said at least one slam bumper includes a threaded body portion that engages an opening in said inner door structure.

3. The frameless door assembly according to claim 2 wherein said at least one slam bumper includes a first body portion with an adjustment feature positioned on one side of said inner door structure and a second body portion with a bump surface positioned on an opposite side of said inner door structure with said threaded body portion extending between said first and said second body portions, said adjustment feature allowing selective adjustment to move said bump surface to a desired position relative to the window panel.

4. The frameless door assembly according to claim 3 wherein said adjustment feature comprises a slot adapted to receive a tool.

5. The frameless door assembly according to claim 3 wherein said second body portion is defined by a diameter that is less than an outer diameter that defines said threaded body portion such that a stop surface transitions between said threaded body portion and said second body portion, said stop surface directly engaging a window regulator rail surface.

6. The frameless door assembly according to claim 5 wherein said at least one slam bumper is selectively adjusted by rotating said adjustment feature until said stop surface contacts said window regulator rail surface to maintain said desired positional relationship between the window panel and said bump surface of said at least one slam bumper.

7. The frameless door assembly according to claim 3 wherein said window regulator rail guides movement of the window panel in a first direction and wherein said adjustment feature is selectively rotated to move said at least one slam bumper in a second direction different than the first direction.

8. The frameless door assembly according to claim 1 wherein the window panel is movable between a fully open position and a fully closed position and wherein said at least one slam bumper comprises a first slam bumper and a second slam bumper, said first slam bumper to support said window regulator rail and the window panel when in the fully closed position, and said second slam bumper to support said window regulator rail and the window panel when in a position between the fully open and the fully closed position.

9. The frameless door assembly according to claim 1 wherein said inner door structure comprises a carrier plate.

10. An adjustable bumper for a frameless door assembly comprising:
a first body portion mountable to an inner door structure, said first body portion including an adjustable attachment interface;
a second body portion including an adjustment feature and positionable on one side of the inner door structure; and
a third body portion including a bump surface and positionable on an opposite side of the inner door structure wherein said adjustment feature is selectively engaged to move said bump surface along said adjustable attachment interface to a desired position relative to a window panel.

11. The adjustable bumper according to claim 10 wherein said adjustable attachment interface comprises a threaded attachment.

12. The adjustable bumper according to claim 10 wherein said adjustment feature comprises a slot adapted to receive a tool.

13. The adjustable bumper according to claim 10 wherein said first, second, and third body portions are formed as a single piece component with said first body portion having a greater diameter than said third body portion such that a stop surface transitions from said first body portion to said third body portion, said stop surface to engage a window regulator rail to define the desired position.

14. A method of installing a window panel in a frameless door assembly comprising:
(a) supporting a window regulator rail and at least one slam bumper on an inner door structure;
(b) adjusting a position of the window regulator rail to move an associated window panel to a proper installation position; and
(c) subsequently adjusting a position of the at least one slam bumper relative to the inner door structure to maintain a desired positional relationship between the at least one slam bumper and the associated window panel.

15. The method according to claim 14 wherein step (c) includes rotating the at least one slam bumper until a stop surface on the at least one slam bumper contacts a window regulator rail surface.

16. The method according to claim 14 including threadably attaching the at least one slam bumper to the inner door structure.

17. The method according to claim 16 including forming an adjustment feature on the at least one slam bumper where the adjustment feature is adapted to receive a tool, and selectively adjusting the position of the at least one slam bumper by rotating the at least one slam bumper via the adjustment feature to axially move the at least one slam bumper along a threaded attachment interface with the inner door structure until the at least one slam bumper contacts the window regulator rail.

18. The method according to claim 14 wherein the at least one slam bumper comprises a first slam bumper and a second slam bumper, and including positioning the first slam bumper at first position on the inner door panel and positioning the second slam bumper at a second position on the inner door panel, vertically higher than the first position, and using the first slam bumper to provide support for the window panel when in a fully open position and using the second slam bumper to provide support for the window panel when at a position between the fully open position and a fully closed position.
